(19) United States
(12) Patent Application Publication
(10) Pub. No.: US 2025/0314842 A1
(43) Pub. Date: Oct. 9, 2025

(54) OPTICAL TRANSCEIVING BOX BODY AND OPTICAL MODULE

(71) Applicant: InnoLight Technology (Suzhou) Ltd., Suzhou, Jiangsu (CN)

(72) Inventor: Jian Zhou, Suzhou , Jiangsu (CN)

(21) Appl. No.: 18/864,636

(22) PCT Filed: Mar. 24, 2023
(86) PCT No.: PCT/CN2023/083800

§ 371 Date: Nov. 11, 2024

(30) Foreign Application Priority Data
May 25, 2022 (CN) 202221286958.8

(51) Int. Cl. G02B 6/42

(52) U.S. Cl. CPC G02B 6/4256; G02B 6/4203

(57) ABSTRACT

An optical transceiving box body (100) and an optical module. The optical transceiving box body (100) comprises a housing (10) and a cover body (20); the housing (10) comprises a cavity (101) having an opening (102); the cavity (101) is used for accommodating an optical assembly; the cover body (20) comprises a protective cover (22) and a closing cover (21); the closing cover (21) closes the opening (102); the protective cover (22) is used for separating the optical assembly from the closing cover (21); the housing (10) further comprises a limiting structure; the protective cover (22) is fixedly connected inside the cavity (101) by means of the limiting structure. In a cover detachment process of the optical transceiving box body (100), the closing cover (21) is removed first, and the protective cover (22) is then removed; under the protection of the protective cover (22), powder generated during the detachment of the closure cover (21) does not fall onto the optical assembly, so that the optical assembly is protected from contamination, the optical assembly can be repeatedly used, production costs are saved, and analysis results of the optical assembly are not affected.

### CROSS-REFERENCE TO RELATED PATENT APPLICATION

This application claims priority to the Chinese patent application filed with the China Patent Office on May 25, 2022, with the application No. 202221286958.8 and the disclosure name “Optical Transceiving Box Body and Optical Module”, the entire content of which is incorporated into this application by reference.

### FIELD OF THE DISCLOSURE

The present disclosure relates to the technical field of optical communication, to an optical transceiving box body, and in particular to an optical module having the optical transceiving box body.

### BACKGROUND OF THE DISCLOSURE

Optical module is a device for realizing mutual conversion of optical and electrical signals, and is one of the key components in optical communication equipment. The optical components in the optical module need to be packaged in a relatively airtight optical transceiving box body to reduce the adverse effects of environmental factors such as humidity, temperature, and electromagnetic interference. The optical transceiving box body includes a housing and a cover. Currently, the housing and the cover are usually fixedly connected by welding.

In the process of realizing the present disclosure, the inventor found that there are at least the following problems in the prior art.

During the production process, there may be cases where defective materials need to be dismantled for rework or dismantled for analysis. After the housing and cover are welded together, the cover needs to be dismantled by mechanical grinding. However, when removing the cover, metal particles may fall into the housing and contaminate the optical components, causing the material to become dirty. On the one hand, it cannot be used again, and on the other hand, it also affects the analysis results.

### SUMMARY OF THE DISCLOSURE

### Technical Problem

In order to solve the problem in the prior art of contaminating internal components when the cover is removed, the purpose of the present disclosure is to provide an optical transceiving box body that is not easily contaminated and an optical module having the optical transceiving box body.

### Technical Solutions

In order to achieve the above purpose of the present disclosure, one embodiment of the present disclosure provides an optical transceiving box body, which includes:
a housing that includes a cavity with an opening for accommodating an optical component;
a cover body, characterized in that the cover body includes a protective cover and a closing cover, the closing cover closes the opening, and the protective cover is used to separate the optical component from the closing cover;
wherein the housing further includes a limiting structure, and the protective cover is fixedly connected to an inside of the cavity through the limiting structure.

As a further improvement of the present disclosure, the housing further includes a limiting ring, the limiting ring surrounds the opening, the limiting structure includes a step portion, the step portion is arranged around the opening, and formed at an indention in a thickness direction of the limiting ring, and the protective cover is fixedly connected to the step portion.

As a further improvement of the present disclosure, the housing further includes a housing body, the optical transceiving box body further includes a connector connected to the housing body, and a lower end surface of the limiting ring is simultaneously connected to an upper end surface of the housing body and an upper end surface of the connector.

As a further improvement of the present disclosure, the housing body and the limiting ring are integrally provided.

As a further improvement of the present disclosure, the closing cover includes a closing body and a closing protrusion protruding from the closing body toward the cavity, the closing body is sealingly connected to the upper end surface of the limiting ring, and the closing protrusion is embedded in the opening.

As a further improvement of the present disclosure, the closing cover is welded and connected to the upper end surface of the limiting ring.

As a further improvement of the present disclosure, the protective cover is fixedly bonded to the step portion through colloid.

As a further improvement of the present disclosure, the protective cover is configured as a transparent piece, and the colloid is configured as light-curing glue.

As a further improvement of the present disclosure, the protective cover and the closing cover are provided separately.

In order to achieve one of the above-mentioned purposes of the present disclosure, an embodiment of the present disclosure provides an optical module, which includes the above-mentioned optical transceiving box body.

### Beneficial Effects

Compared with the existing technology, the present disclosure has the following beneficial effects. In the process of removing the cover of the optical transceiving box body, the closing cover is removed first, and then the protective cover is removed. Since it is protected by the protective cover, the closing cover can be disassembled. The powder produced will not fall onto the optical components, thus protecting the optical components from contamination. The optical components can be reused, saving production costs, and will not affect the analysis results of the optical components.

### BRIEF DESCRIPTION OF THE DRAWINGS

FIG. 1 is a schematic structural diagram of an optical transceiving box body according to an embodiment of the present disclosure;

FIG. 2 is an exploded view of an optical transceiving box body according to an embodiment of the present disclosure;

FIG. 3 is an exploded view of the optical transceiving box body from another angle according to an embodiment of the present disclosure; and

FIG. 4 is a cross-sectional view of an optical transceiving box body according to an embodiment of the present disclosure;

in which, 100. Optical transceiving box body; 101. Cavity; 102. Opening; 10. Housing; 11. Housing body; 111. First upper end face; 12. Limiting ring; 121. Second upper end face; 122. Lower end surface; 123. Step portion; 20. Cover body; 21. Closing cover; 211. Closing protrusion; 212. Closing body; 22. Protective cover; 30. Connector; 40. Light window.

### DETAILED DESCRIPTION OF THE EXEMPLARY EMBODIMENTS

The present disclosure will be described in detail below with reference to the specific embodiments shown in the accompanying drawings. However, these embodiments do not limit the present disclosure. Structural, method, or functional changes made by those of ordinary skill in the art based on these embodiments are all included in the protection scope of the present disclosure.

It should be understood that the terms used herein, such as “upper”, “above”, “lower”, “below”, etc., indicating spatial relative positions are used for the purpose of convenience to describe the relationship of one unit or feature relative to another unit or feature as shown in the drawings. The terms of spatial relative positions may be intended to include different orientations of the device in use or operation other than the orientation shown in the drawings.

One embodiment of the present disclosure provides an optical transceiving box body that is not easily contaminated and an optical module having the optical transceiving box body.

The core function of an optical module is to realize mutual conversion between optical signals and electrical signals. This mutual conversion process occurs in the optical transceiving box body 100 of the optical module. The optical transceiving box body 100 is provided with optical components, which include integrated amplifier circuits, light emitting components, light receiving components and other components. The optical transceiving box body 100 is provided with a connector 30 on one side thereof and a light window 40 on the other side thereof. The connector 30 is connected to the flexible circuit board, and the light window 40 is connected to the optical fiber adapter. The connector 30 can be made of ceramic material, and the light window 40 can be made of transparent material, such as a glass sheet. The inside of the optical transceiving box body 100 is relatively airtight, and can be evacuated first and then filled with inert gas to prevent the internal structure from being oxidized.

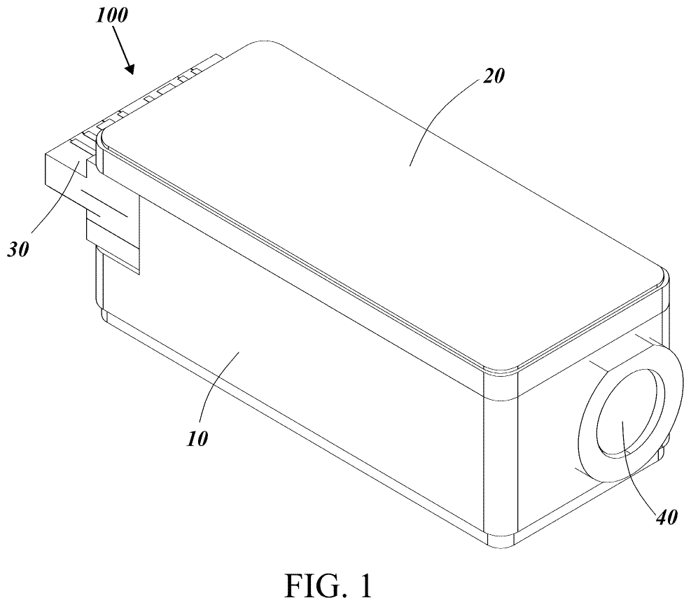

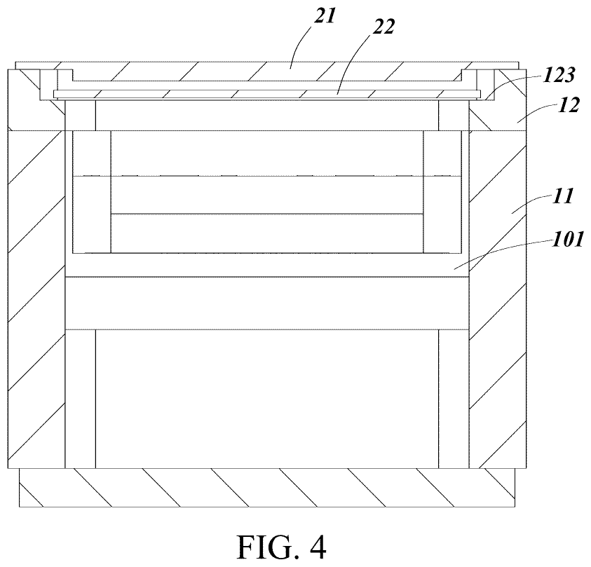

An optical transceiving box body 100 disclosed in one embodiment of the present disclosure, as shown in FIGS. 1-4, includes a housing 10 and a cover body 20. The housing 10 includes a cavity 101 with an opening 102. The cavity 101 accommodates the above-mentioned optical components; the cover body 20 includes a protective cover 22 and a closing cover 21, the closing cover 21 closes the opening 102, the protective cover 22 is used to separate the optical components from the closing cover 21; the housing 10 further includes a limiting structure, the protective cover 22 is fixedly connected to the inside of the cavity 101 through the limiting structure.

To clearly express the position and direction described in this embodiment, in this embodiment, the opening 102 is defined to be located above the cavity 101, and the opposite direction is defined as downward. That is to say, the cover body 20 is connected to the housing 10 from above. The connector 30 is connected to the left side of the housing 10, and the light window 40 is located on the right side of the housing 10. The optical transceiving box body 100 can be a structure similar to a rectangular parallelepiped, and the surfaces of the opening 102 and the cover body 20 can be parallel to the horizontal plane. The term “horizontal plane’” is a naming convention and is not physically constrained to being horizontal.

The material of the housing 10 and the closing cover 21 can be metal, and the closing cover 21 and the housing 10 are welded. The protective cover 22 can be made of plastic material, such as PEI, or ordinary machined materials. The protective cover 22 is easily detachable from the housing 10, so that when the closing cover 21 is disassembled and generates debris, it falls on the protective cover. After cleaning the surface of the protective cover 22, the protective cover 22 is removed, so that the internal optical components are not contaminated by debris.

There are many embodiments of the limiting structure, specifically in this embodiment.

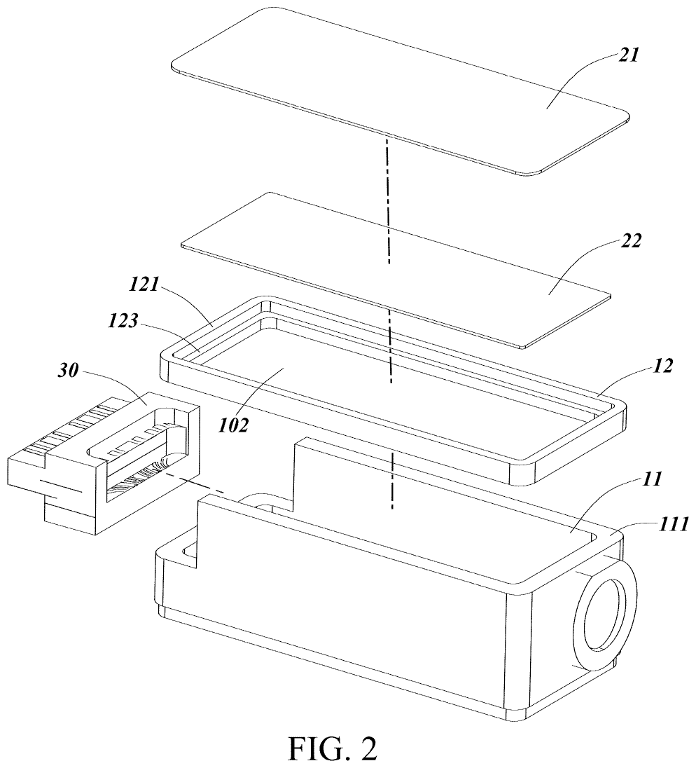

As shown in FIGS. 2 to 4, the housing 10 includes a housing body 11 and a limiting ring 12. The limiting ring 12 is connected to the housing body 11. The limiting ring 12 surrounds the opening 102. The limiting structure further includes a step portion 123 arranged around the opening 102, the step portion 123 is provided in the limiting ring 12, the step portion 123 is formed at an indention in the thickness direction of the limiting ring 12, and the protective cover 22 is fixedly connected to the step portion 123.

The thickness direction of the limiting ring 12 refers to the thickness between the inside of the cavity 101 and the outside of the cavity 101 on a plane parallel to the opening. The step portion 123 separates the wall thickness of the limiting ring 12 into a thicker first thickness and a thinner second thickness, where the first thickness is the same as the thickness of the housing body 11, the second thickness is thinner than the thickness of the housing body 11, and the outer contour of the limiting ring 12 is consistent with the outer contour of the housing body 11 at the connection position. The protective cover 22 is placed on the step portion 123 from above and is fixedly connected to the step portion 123.

In other embodiments of the limiting structure, the limiting structure may be a screwed structure, a clamping structure, an adhesive structure, etc., and the protective cover 22 is fixed to the inner wall of the housing 10 through bolting, adhesion, buckle connection, etc.

And in other embodiments, the step portion 123 can be formed in the following manner.

The wall thickness of the limiting ring 12 is narrower than the wall thickness of the housing body 11. When the limiting ring 12 is connected to the housing body 11, the step portion 123 is defined simultaneously by the limiting ring 12 and the housing body 11, the protective cover 22 is fixed on the upper end surface of the housing body 11, and the limiting ring 12 surrounds the outside of the protective cover 22.

Returning to this embodiment, for the convenience of description, the upper end surface of the housing body 11 is named the first upper end surface 111, the upper end surface of the limiting ring 12 is named the second upper end surface 121, and the lower end surface 122 refers to the lower end surface 122 of the limiting ring 12.

The lower end surface 122 is connected to the first upper end surface 111, the second upper end surface 121 is connected to the closing cover 21, the limiting ring 12 is located between the housing body 11 and the closing cover 21, the step portion 123 is formed in the limiting ring 12, and the protective cover 22 is fixed in the limiting ring 12.

The step portion 123 can be parallel to the horizontal plane, and the lower surface of the protective cover 22 is also parallel to the horizontal plane. After the protective cover 22 is placed on the surface of the step portion 123, the two are fixedly connected to each other.

In this embodiment, the protective cover 22 is bonded to the step portion 123 through colloid. In addition, the protective cover 22 can also be connected to the step portion 123 through bolts, buckles and other structures.

Further, the protective cover 22 is configured as a transparent piece, and the colloid is configured as a light-curing glue, such as UV glue. UV glue is applied between the protective cover 22 and the step portion 123, and then the UV glue is cured by ultraviolet irradiation, and the protective cover 22 is fixedly connected to the housing 10. When the protective cover 22 needs to be removed, the viscosity of the colloid can be removed by heating, using a solvent, etc.

In this embodiment, the closing cover 21 is welded and connected to the second upper end surface 121, more specifically through parallel sealing and welding, to improve the air tightness in the cavity 101 and prevent external air from entering the optical transceiving box body 100. The closing cover 21 can also be fixed on the housing 10 by methods such as bolting, bonding, snapping, etc.

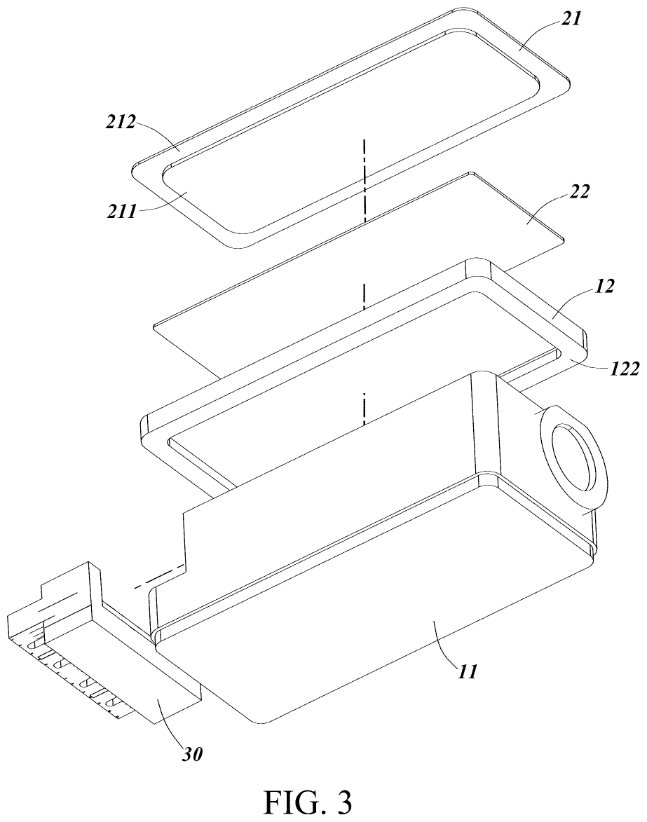

In addition, as shown in FIG. 3, the closing cover 21 includes a closing body 212 and a closing protrusion 211 protruding from the closing body 212 toward the cavity 101. The closing protrusion 211 is embedded in the opening 102, the closing body 212 is connected to the second upper end surface 121, and the closing protrusion 211 can play a positioning role to accurately embed the closing cover 21 in the opening 102. In addition, it also plays a role in preventing the closing cover 21 from falling into the cavity 101 when it is disassembled. When the closing protrusion 211 is not provided and the closing cover 21 is disassembled, debris enters the cavity 101 through the gap between the closing body 212 and the second upper end surface 121. After the closing protrusion 211 is provided, and when the closing cover 21 is disassembled, the debris between the closing body 212 and the second upper end surface 121 is blocked after reaching the position of the closing protrusion 211, so that the debris is more difficult to enter the cavity 101, thereby reducing the amount of the debris falling on the protective cover 22, so as to further protect the optical components from contamination.

Further, the protective cover 22 is separated from the closing cover 21. In the process of disassembling the optical transceiving box body 100, the closing cover 21 welded to the housing body 11 is first removed. The separation of the protective cover 22 and the closing cover 21 is beneficial to protecting the protective cover 22 during the disassembly process, especially protecting the protective cover 22 made of transparent PEI plastic material, so that the disassembly of the closing cover 21 will not damage the protective cover 22, and the debris will not fall on the optical component. After the closing cover 21 is removed, the powder on the surface of the protective cover 22 is cleaned, and then the protective cover 22 is disassembled by heating. No powder will be generated during the disassembly of the protective cover 22, so that the purpose of pollution-free disassembly is achieved.

Further, the optical transceiving box body 100 further includes a connector 30 connected to the housing body 11. The lower end surface 122 of the limiting ring 12 is simultaneously connected to the first upper end surface 111 and the upper end surface of the connector 30, as shown in FIG. 2 or FIG. 3. As shown, the housing body 11, the connector 30, and the limiting ring 12 are connected by welding.

Compared with the existing technology, this embodiment has the following beneficial effects.

During the process of removing the cover of the optical transceiving box body 100, the closing cover 21 is removed first, and then the protective cover 22 is removed. Since it is protected by the protective cover 22, the powder generated when the closing cover 21 is removed will not fall into the optical components, thereby protecting the optical components from contamination, allowing the optical components to be reused, saving production costs, and not affecting the analysis results of the optical components.

It should be understood that although this specification is described in terms of implementations, not each implementation only contains an independent technical solution. This description of the specification is only for the sake of clarity. Persons skilled in the art should take the specification as a whole and understand each individual solution. The technical solutions in the embodiments can also be appropriately combined to form other embodiments that can be understood by those skilled in the art.

The series of detailed descriptions listed above are only specific descriptions of feasible implementations of the present disclosure. They are not intended to limit the protection scope of the present disclosure. Any equivalents that do not deviate from the technical spirit of the present disclosure. All implementations or changes should be included in the protection scope of the present disclosure.

1. An optical transceiving box body, which includes:
a housing that includes a cavity with an opening, the cavity being used for accommodating an optical component;
a cover body, characterized in that the cover body includes a protective cover and a closing cover, the closing cover closes the opening, and the protective cover is used to separate the optical component from the closing cover;
wherein the housing further includes a limiting structure, and the protective cover is fixedly connected to an inside of the cavity through the limiting structure.

2. The optical transceiving box body according to claim 1, characterized in that the housing further includes a limiting ring, the limiting ring surrounds the opening, the limiting structure includes a step portion, the step portion is arranged around the opening, and formed at an indentation in a thickness direction of the limiting ring, and the protective cover is fixedly connected to the step portion.

3. The optical transceiving box body according to claim 2, characterized in that the housing further includes a housing body, the optical transceiving box body further includes a connector connected to the housing body, and a lower end surface of the limiting ring is simultaneously connected to an upper end surface of the housing body and an upper end surface of the connector.

4. The optical transceiving box body according to claim 3, characterized in that the housing body and the limiting ring are integrally provided.

5. The optical transceiving box body according to claim 2, characterized in that the closing cover includes a closing body and a closing protrusion protruding from the closing body toward the cavity, the closing body is sealingly connected to the upper end surface of the limiting ring, and the closing protrusion is embedded in the opening.

6. The optical transceiving box body according to claim 5, characterized in that the closing cover is welded and connected to the upper end surface of the limiting ring.

7. The optical transceiving box body according to claim 2, characterized in that the protective cover is fixedly bonded to the step portion through colloid.

8. The optical transceiving box body according to claim 7, characterized in that the protective cover is configured as a transparent piece, and the colloid is configured as light-curing glue.

9. The optical transceiving box body according to claim 7, characterized in that the protective cover and the closing cover are provided separately.

10. An optical module, characterized in that the optical module includes an optical transceiving box body according to claim 1.
